(19) United States
(12) Patent Application Publication
(10) Pub. No.: US 2017/0153846 A1
(43) Pub. Date: Jun. 1, 2017

(54) RACK SYSTEM

(71) Applicant: MITAC COMPUTING TECHNOLOGY CORPORATION, Taoyuan City (TW)

(72) Inventors: Li-Tien CHANG, Taoyuan City (TW); Kwang-Chao CHEN, Taoyuan City (TW)

(21) Appl. No.: 15/344,790

(22) Filed: Nov. 7, 2016

(30) Foreign Application Priority Data
Nov. 26, 2015 (TW) 104139404

(51) Int. Cl. G06F 3/06; G06F 13/28

(52) U.S. Cl. CPC G06F 3/0647; G06F 3/0613; G06F 3/0683; G06F 13/28

(57) ABSTRACT

A rack system includes a first ROM, a first RAM, a first control unit configured to access the first ROM, a second ROM, a second RAM, and a second control unit electrically connected to the first control unit via a communication channel and configured to access the second ROM. The first control unit is operable, in response to receipt of a request signal from the second control unit for accessing data from the first ROM, to read the data from the first ROM and to transmit the data to the second control unit via the communication channel. The second control unit is operable, upon receipt of the data from the first control unit, to store the data in the second RAM and to access the data from the second RAM.

### CROSS-REFRENCE TO RELATED APPLICATION

This application claims priority of Taiwanese Patent Application No. 104139404, filed on Nov. 26, 2015.

### FIELD

The disclosure relates to a system, more particularly to a rack system.

### BACKGROUND

In the field of computers, particularly of servers, an expandable storage architecture, such as Just a Bunch Of Disks (JBOD), that can be expanded on demand is necessary. Upon increase of the number of the hard disks in a server rack, it is relatively complex for a controller of the server rack to coordinate proper functioning of all hard disks. Hence, an architecture of a server rack with redundant function includes two SAS expanders that serve as controllers for the hard disks, and the SAS expanders are configured to be redundant to each other. In more detail, when one of the SAS expanders that is operated in a master mode cannot function properly, the other one of the SAS expanders that is operated in a slave mode can timely replace the one by operating in the master mode, take over control of the hard disks, and inform a host server of the circumstance.

For example, a conventional rack system, which is shown in FIG. 1, is electrically connected to a host server 99 and includes an enclosure, a back panel, first and second circuit boards removably mounted on the back panel, a first control unit 91, a second control unit 92, a first read only memory (ROM) 93, a second ROM 94, and a storage device 98 including a plurality of hard drives. The first control unit 91 and the first ROM 93 are disposed on the first circuit board, and the second control unit 92 and the second ROM 94 are disposed on the second circuit board. When the first and second circuit boards are mounted on the back panel, the first and second control units 91, 92 and the first and second ROMs 93, 94 are electrically connected to each other via a bus (S9) which supports an inter-integrated circuit (I²C) protocol. One of the first and second control units 91, 92 is operable in a master mode to access the storage device 98, and the other one of the first and second control units 91, 92 is operable in a slave mode to serve as a backup device

Due to the electrical connection among the first and second control units 91, 92 and the first and second ROMs 93, 94, each of the first and second control units 91, 92 can access the first and second ROMs 93, 94 directly. However, when both of the first and second control units 91, 92 are simultaneously accessing the same one of the first and second ROMs 93, 94, data accessing conflicts may occur in the bus (S9) and result in failure of data reading or data misreading of the first and second control units 91, 92.

### SUMMARY

Therefore, an object of the disclosure is to provide a rack system that can alleviate at least one of the drawbacks of the prior art.

According to the disclosure, a rack system includes a first input/output module (IOM) and a second IOM. The first IOM includes a first ROM, a first RAM, a first control unit electrically connected to the first RAM and the first ROM and configured to access the first ROM via a first read channel. The second IOM includes a second ROM, a second RAM, and a second control unit electrically connected to the first control unit via a communication channel, electrically connected to the second RAM and the second ROM, and configured to access the second ROM via a second read channel.

The first control unit is operable, in response to receipt of a request signal from the second control unit for accessing data from the first ROM, to read the data from the first ROM via the first read channel and to transmit the data to the second control unit via the communication channel.

The second control unit is operable, upon receipt of the data from the first control unit, to temporarily store the data in the second RAM and to access the data from the second RAM.

### BRIEF DESCRIPTION OF THE DRAWINGS

Other features and advantages of the disclosure will become apparent in the following detailed description of the embodiment with reference to the accompanying drawings, of which:

FIG. 1 is a block diagram illustrating a conventional rack system; and

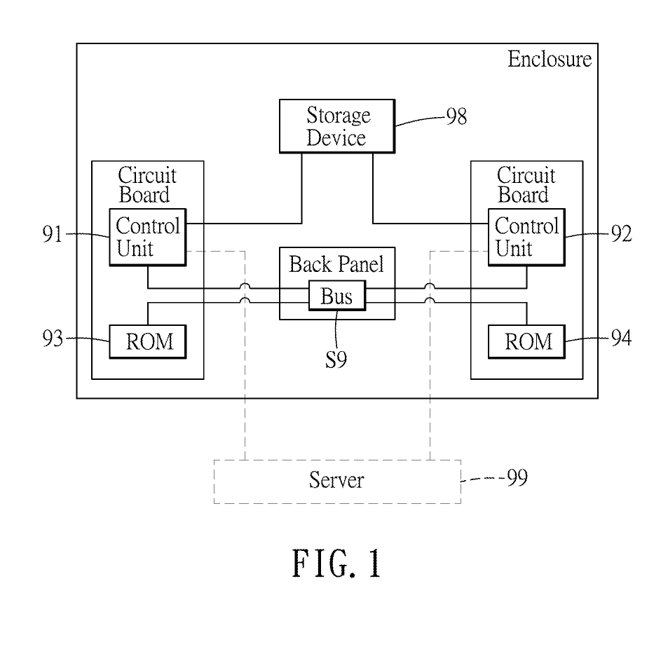

FIG. 2 is a block diagram illustrating a rack system of an exemplary embodiment according to the disclosure.

### DETAILED DESCRIPTION

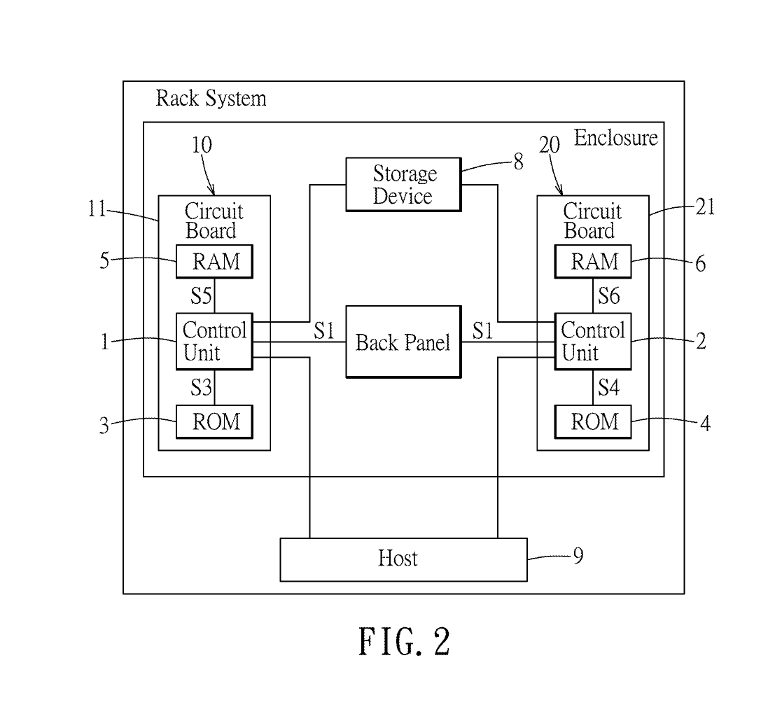

Referring to FIG. 2, the exemplary embodiment of a rack system according to the present disclosure includes an enclosure, a back panel, a first input/output module (IOM) 10, a second IOM 20, a storage device 8 and a host 9. The back panel is mounted to the enclosure, and the enclosure contains the storage device 8. The enclosure containing the back panel, the first IOM 10, the second IOM 20 and the storage device 8 can be considered an expansion device of the host 9. It is worth noting that the host 9 may be a server or a computer, but is not limited hereto according to the present disclosure.

The first IOM 10 includes a first circuit board 11 removably mounted on the back panel, a first control unit 1, a first ROM 3, a first RAM 5, a first read channel (S3), and a first access channel (S5). The first control unit 1, the first ROM 3 and the first RAM 5 are disposed on the first circuit board 11, and the first read channel (S3) and the first access channel (S5) are formed on the first circuit board 11. The first control unit 1 is electrically connected to the first ROM 3 and the first RAM 5, and is configured to access the first ROM 3 via the first read channel (S3), and to access the first RAM 5 via the first access channel (S5). The first control unit 1 may be a Serial Attached Small Computer Interface (SAS) expander in this embodiment, and is directly and electrically connected to the host 9. In other embodiments, the first control unit 1 may be electrically connected to the host 9 through the back panel. The first ROM 3 may be a field-replaceable unit, and in this embodiment the first ROM 3 is an electrically-erasable programmable read-only memory (EEPROM). The first ROM 3 may store data including set values, lookup tables and part numbers that are associated with the host 9, the storage device 8 and/or the rack system. The first read channel (S3) may support an inter-integrated circuit (I²C) protocol. In this embodiment, the first RAM 5 is a non-volatile static random access memory (NVSRAM). The first access channel (S5) of this embodiment supports an external memory interface protocol, is electrically connected between the first control unit 1 and the first RAM 5, and allows the first control unit 1 to access the first RAM 5 therethrough.

Similarly, the second IOM 20 of this embodiment includes a second circuit board 21 removably mounted on the back panel, a second control unit 2, a second ROM 4, a second RAM 6, a second read channel (S4), and a second access channel (S6). The second control unit 2, the second ROM 4, and the second RAM 6 are disposed on the second circuit board 21, and the second read channel (S4) and the second access channel (S6) are formed on the second circuit board 21. The second control unit 2 is electrically connected to the first control unit 1 via a communication channel (S1), and is electrically connected to the second ROM 4 and the second RAM 6. In this embodiment, the second control unit 2 is configured to access the second ROM 4 via the second read channel (S4), and to access the second RAM 6 via the second access channel (S6). The second control unit 2 may be a SAS expander in this embodiment, and is also directly and electrically connected to the host 9. In other embodiments, the second control unit 2 may be electrically connected to the host 9 through the back panel. The second ROM 4 may be a field-replaceable unit, and in this embodiment the second ROM 4 is an EEPROM. The second ROM 4 may store data including set values, lookup tables and part numbers that are associated with the host 9, the storage device 8 and/or the rack system. In this embodiment, the second RAM 6 is an NVSRAM. In this embodiment, the second read channel (S4) supports an I²C protocol, and the second access channel (S6) supports the external memory interface protocol. The second access channel (S6) is electrically connected between the second control unit 2 and the second RAM 6, and allows the second control unit 2 to access the second RAM 6 therethrough.

In this embodiment, the first control unit 1 is configured to be restricted from directly accessing the second ROM 4, and the second control unit 2 is configured to be restricted from directly accessing the first ROM 3. That is, the second control unit 2 cannot directly access the first ROM 3 disposed on the first circuit board 11, and similarly the first control unit 1 cannot directly access the second ROM 4 disposed on the second circuit board 21. In practice, the first control unit 1 and the second control unit 2 are restricted from directly accessing the second ROM 4 and the first ROM 3, respectively, by hardware layout. For example, the first ROM 3 and the second ROM 4 are connected to a specific bus (e.g., “BUS 4”) that cannot communicate through the back panel. Accordingly, the SAS expander (i.e., the first and second control units 1, 2) cannot access the field-replaceable unit (i.e., the first and second ROMs 3, 4) that is not directly connected to the SAS expander.

The back panel includes the communication channel (S1) and supports a SAS protocol. The first control unit 1 and the second control unit 2 are electrically interconnected via the communication channel (S1) when the first circuit board 11 and second circuit board 21 are mounted on the back panel. The first and second control units 1, 2 are configured to communicate with each other through the communication channel (S1) that is an internal physical layer. It should be noted that the communication channel (S1), the first read channel (S3), the second read channel (S4), the first access channel (S5), and second access channel (S6) are separated from each other. In other embodiments, the first circuit board 11, the second circuit board 21 and the back panel are integrated into a single circuit board.

The storage device 8 includes a plurality of hard drives and is electrically connected to the first control unit 1 and the second control unit 2. In this embodiment, one of the first and second control units 1, 2 may be operable in a master mode to access the storage device 8, and accordingly the other one of the first and second control units 1, 2 may be operable in a slave mode to be a backup device.

The first control unit 1 is operable, in response to receipt of a request signal from the second control unit 2 for accessing data from the first ROM 3, to read the data from the first ROM 3 via the first read channel (S3) and to transmit the data to the second control unit 2 via the communication channel (S1). The second control unit 2 is operable, upon receipt of the data from the first control unit 1, to temporarily store the data in the second RAM 6 and to access the data from the second RAM 6. In other words, when the second control unit 2 tries to access the data stored in the first ROM 3 that is not directly accessible, the second control unit 2 may send an in-band signal as the request signal to the first control unit 1 according to the SAS protocol via the communication channel (S1). When the first control unit 1 receives the request signal, the first control unit 1 accesses the data stored in the first ROM 3 and transmits the data to the second control unit 2. Thereafter, the second control unit 2 temporarily stores the data in the second RAM 6, and then accesses the data from the second RAM 6.

Similarly, the second control unit 2 is operable, in response to receipt of a request signal from the first control unit 1 for accessing data from the second ROM 4, to read the data from the second ROM 4 via the second read channel (S4) and to transmit the data to the first control unit 1 via the communication channel (S1). The first control unit 1 is operable, upon receipt of the data from the second control unit 2, to temporarily store the data in the first RAM 5 and to access the data from the first RAM 5. In other words, when the first control unit 1 tries to access the data stored in the second ROM 4 that is not directly accessible, the first control unit 1 may send an in-band signal as the request signal to the second control unit 2 according to the SAS protocol via the communication channel (S1). When the second control unit 2 receives the request signal, the second control unit 2 accesses the data stored in the second ROM 4 and transmits the data to the first control unit 1. Thereafter, the first control unit 1 temporarily stores the data in the first RAM 5 and then accesses the data from the first RAM 5.

It is worth noting that the each of the first and second ROMs 3, 4 may have less capacity than that of each of the first and second RAMs 5, 6. For instance, each of the first and second ROMs 3, 4 may have a capacity of 8 kilobytes (KB), whereas each of the first and second RAMs 5, 6 may have a capacity of 128 KB. As such, the first control unit 1 (or the second control unit 2) can, upon receipt of the request signal from the second control unit 2(or the first control unit 1), access and transmit the whole data stored in the first ROM 3 (or the second ROM 4) to the second control unit 2(or the first control unit 1), and the second control unit 2 (or the first control unit 1) may temporarily store the whole data in the second RAM 6 (or the first RAM 5) and access the same therefrom.

In summary, by way of the separated channels, i.e., the first and second read channels (S3, S4), the first and second access channels (S5, S6) and the communication channel (S1), the first and second control units 1, 2 are restricted from directly and correspondingly accessing the first and second ROMs 3, 4, so that the aforesaid problem involving data accessing conflicts can be prevented.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A rack system comprising:
a first input/output module (IOM) including
a first read only memory (ROM),
a first random access memory (RAM), and
a first control unit electrically connected to said first RAM and said first ROM, and configured to access said first ROM via a first read channel; and
a second IOM including
a second ROM,
a second RAM, and
a second control unit electrically connected to said first control unit via a communication channel, electrically connected to said second RAM and said second ROM, and configured to access said second ROM via a second read channel,
wherein said first control unit is operable, in response to receipt of a request signal from said second control unit for accessing data from said first ROM, to read the data from said first ROM via said first read channel and to transmit the data to said second control unit via said communication channel; and
wherein said second control unit is operable, upon receipt of the data from said first control unit, to store the data in said second RAM and to access the data from said second RAM.

2. The rack system of claim 1, wherein said second control unit is operable, in response to receipt of a request signal from said first control unit for accessing data from said second ROM, to read the data from said second ROM via said second read channel and to transmit the data to said first control unit via said communication channel, and
wherein said first control unit is operable, upon receipt of the data from said second control unit, to store the data in said first RAM and to access the data from said first RAM.

3. The rack system of claim 1, further comprising a back panel including said communication channel;
wherein said first IOM further includes a first circuit board removably mounted on said back panel, and including said first read channel, wherein said first ROM, said first RAM and said first control unit are disposed on said first circuit board; and
wherein said second IOM further includes a second circuit board removably mounted on said back panel, and including said second read channel, wherein said second ROM, said second RAM and said second control unit are disposed on said second circuit board.

4. The rack system of claim 3, wherein said first control unit and said second control unit are electrically interconnected via said communication channel when said first and second circuit boards are mounted on said back panel.

5. The rack system of claim 3, wherein said first circuit board further includes a first access channel that is electrically connected between said first control unit and said first RAM and that allows said first control unit to access said first RAM therethrough, and said second circuit board further includes a second access channel that is electrically connected between said second control unit and said second RAM and that allows said second control unit to access said second RAM therethrough.

6. The rack system of claim 5, wherein said first and second access channels support an external memory interface protocol.

7. The rack system of claim 5, wherein said first and second read channels, said first and second access channels and said communication channel are separated from each other.

8. The rack system of claim 1, wherein said first read channel and said second read channel support an inter-integrated circuit (I²C) protocol.

9. The rack system of claim 1, wherein said communication channel supports a serial attached small computer system interface (serial attached SCSI; SAS) protocol.

10. The rack system of claim 9, wherein said first control unit and said second control unit are configured to be electrically connected to a server, and are SAS expanders.

11. The rack system of claim 9, wherein said second control unit is configured to send an in-band signal as the request signal to said first control unit according to the SAS protocol.

12. The rack system of claim 1, wherein said first control unit and said second control unit are configured to be electrically connected to a host.

13. The rack system of claim 12, the host being a server,
wherein said first control unit and said second control unit are SAS expanders.

14. The rack system of claim 12, wherein the data stored in said first ROM includes set values, lookup tables and part numbers that are associated with the host and the rack system.

15. The rack system of claim 1, wherein said first control unit is configured to be restricted from directly accessing said second ROM, and said second control unit is configured to be restricted from directly accessing said first ROM.

16. The rack system of claim 1, further comprising a storage device that includes a plurality of hard drives and that is electrically connected to said first control unit and said second control unit.

17. The rack system of claim 16, wherein one of said first and second control units is operable in a master mode to access said storage device, and the other one of said first and second control units is operable in a slave mode to be a backup device.

18. The rack system of claim 16, wherein the data stored in said first ROM includes set values, lookup tables and part numbers that are associated with said storage device.

19. The rack system of claim 1, wherein said first ROM and said second ROM are field-replaceable units.

20. The rack system of claim 1, wherein said first ROM and said second ROM are electrically-erasable programmable read-only memories (EEPROM), and said first RAM and said second RAM are non-volatile static random access memories (NVSRAM).
